(19) United States
(12) Patent Application Publication
(10) Pub. No.: US 2018/0180220 A1
(43) Pub. Date: Jun. 28, 2018

(54) ASSEMBLY FOR A CONDENSATE EXTRACTOR FOR EXTRACTING A COMPRESSED GAS CONDENSATE

(71) Applicant: BEKO TECHNOLOGIES GMBH, Neuss (DE)

(72) Inventors: Karsten ROTTER, Korschenbroich (DE); Johannes SINSTEDTEN, Korschenbroich (DE)

(73) Assignee: BEKO TECHNOLOGIES GMBH, Neuss (DE)

(21) Appl. No.: 15/739,590

(22) PCT Filed: Apr. 11, 2017
(86) PCT No.: PCT/EP2017/058608

§ 371 Date: Dec. 22, 2017

(30) Foreign Application Priority Data
Apr. 22, 2015 (DE) 10 2016 107 500.0

(51) Int. Cl. F16T 1/48; F16T 1/12; F04B 39/16; F04B 49/06

(52) U.S. Cl. CPC F16T 1/48; F16T 1/12; G05D 9/12; F04B 49/06; F04B 39/16

(57) ABSTRACT

An assembly for a condensate draining device for draining off a compressed-gas condensate includes a collecting chamber for receiving the compressed-gas condensate formed in a compressed-gas system, an electrically operated outlet valve for discharging the compressed-gas condensate from the collecting chamber, and an interface for attaching the assembly to an electronic module. The interface has a contact assembly for supplying the outlet valve with electricity from the electronic module. The interface is brought into one of several possible and different configuration states.

### TECHNICAL FIELD

The disclosure relates to an assembly for a condensate draining device for draining off a compressed-gas condensate having the features of the preamble of claim 1, and to a condensate draining device for draining off a compressed-gas condensate having the features of the preamble of claim 13.

### BACKGROUND

Condensate, which may also contain oil and other contaminants in addition to water, is regularly formed in compressed-gas systems and, in particular, compressed-air systems. The oil is mainly produced in compressors, in which it is used as a lubricant. Generally, the condensate in compressed-gas systems is very aggressive and therefore harmful to the compressed-gas system, which is why it must be regularly collected and discharged from the compressed-gas system, which is closed in principle. In the process, a gas pressure loss is supposed to be avoided or minimized, if possible, when the compressed-gas condensate is discharged or drained off. Generic condensate draining devices carry out this task.

As components that are generally present, condensate draining devices have a collecting chamber for receiving the compressed-gas condensate, an outlet valve for discharging the compressed-gas condensate and a sensor for detecting a filling level of the collecting chamber. For operation, such condensate draining devices are generally connected to an external voltage source which provides the condensate draining device with, for example, a customary alternating voltage of 230 V. These condensate draining devices must be subjected to regular maintenance because their function is affected by wear and contamination as the operating time increases. However, this wear generally concerns only the mechanical components of the condensate draining device, whereas the electric components of the condensate draining device do not require such frequent maintenance.

DE 10 2005 028 632 A1, on which the present disclosure is based, describes a generic condensate draining device divided into two assemblies. In this case, the main wear parts are arranged in one assembly of the two assemblies which is referred to as a maintenance assembly, which wear parts include primarily the collecting chamber itself as well as the outlet valve. In contrast, the electric devices, and in particular the external electrical terminal, can be found in the other assembly, which may also be referred to as the electronic module. This condensate draining device enables the replacement of the maintenance assembly and thus of the wear parts located therein without having to disassemble the electronic module any further or disconnect it from the external electrical voltage source at all. A fresh maintenance assembly with unworn components can then simply be attached to the corresponding interface of the electronic module, which electronic module need not be modified any further for this process. For the sake of convenience, the maintenance assembly is hereinafter always simply referred to as an assembly. Since both a disconnection from the external electrical voltage source and a re-connection to the external electrical voltage source have to be carried out by specially trained personnel, the maintenance effort is considerably reduced in this condensate draining device due this disconnection and connection process being dispensable.

Generally, a plurality of condensate draining devices disposed at different locations of the compressed-gas system are used in a compressed-gas system. In this case, the operational requirements for the respective condensate draining devices are different, depending, for example, on the process engineering-related position in the compressed-gas system, which also necessitates different parameterizations or other settings of the condensate draining device. For example, considerably more compressed-gas condensate is generally formed in the area of the separator of the aftercooler in an air compressor than in the compressed-air tank or in compressed-air filters, wherein a greater oil fraction is to be expected in the compressed-air filters. These differences are also significant with respect to the parameterization or the design of the maintenance assembly described above.

### SUMMARY

Therefore, the above-described condensate draining device is disadvantageous in that, in a certain condensate draining device, a maintenance assembly could be attached to an electronic module, which maintenance assembly is unsuitable for this condensate draining device or the process engineering-related position of the condensate draining device in the compressed-gas system with respect to its design or parameterization.

Based on this prior art, the disclosure provides an assembly to reduce the error susceptibility in the maintenance of condensate draining devices.

With regard to an assembly for a condensate draining device for draining off a compressed-gas condensate having the features of the preamble of claim 1, the object is achieved by the features of the characterizing portion of claim 1. With regard to a condensate draining device for draining off a compressed-gas condensate having the features of the preamble of claim 13, the object is achieved by the features of the characterizing portion of claim 13.

The insight that the assembly can be encoded by being capable of being brought into one of several possible configurations is essential to the disclosure. By assigning the individual configuration options of the assembly to one parameterization and/or design each, there is the possibility of ensuring, by means of the respective current configuration of the assembly, that the parameterization and/or the design of the assembly matches the electronic module to which it is to be attached and the process engineering-related position of the corresponding condensate draining device.

The assembly according to the disclosure is intended for a condensate draining device, which condensate draining device is configured for draining off a compressed-gas condensate. The assembly according to the disclosure has a collecting chamber for receiving the compressed-gas condensate formed in a compressed-gas system, an electrically operated outlet valve for discharging the compressed-gas condensate from the collecting chamber, and an interface for attaching the assembly to an electronic module. In this case, the interface has a contact assembly for supplying the outlet valve with electricity from the electronic module. In other words, the outlet valve is supplied with electricity by the electronic module, which supply is carried out via the interface. In particular, the outlet valve may be an electrically switchable solenoid valve. Preferably, the contact assembly for electrically switching the outlet valve may be configured so that the outlet valve therefore receives switching pulses through the contact assembly.

The assembly according to the disclosure is characterized in that the interface can be brought into one of several possible and different configuration states. In other words, there are several different configuration states that the interface can assume. Specifically, the interface then is in a special configuration state of the several configuration states. This enables the electronic module to check the parameterization and/or the design of the assembly based on the configuration state that can encode this parameterization and/or design.

A preferred embodiment of the assembly according to the disclosure is characterized in that at least some of the possible configuration states correspond to a respective mechanical configuration state. Consequently, the configuration states in any case differ in a mechanical manner, which includes, in particular, every difference in the geometry of the interface. It is also possible that all possible configuration states correspond to a respective mechanical configuration state.

It is further preferred that the interface has a plurality of spaced-apart configuration positions, each of which can be shaped into one of several mechanical configuration variants, and that each different configuration variant of a configuration position corresponds to a different configuration state. Thus, the configuration positions correspond to special geometric positions or areas of the interface, each of which can be mechanically shaped in a different manner.

Another preferred embodiment of the assembly according to the disclosure is characterized in that a respective configuration member can optionally be disposed at at least some configuration positions, wherein the presence of a configuration member at the respective configuration position corresponds to a first configuration variant of the configuration position, and the absence of a configuration member from the respective configuration position corresponds to a second configuration variant of the configuration position. Preferably, a respective configuration member can optionally be disposed at all configuration positions. Thus, such configuration members are mechanical components which may be present at or absent from a respective configuration position. It is therefore obvious that a mechanical difference between the two cases is provided simply due to their presence or absence. The configuration positions are preferably receiving portions for arranging a respective configuration member. Here, it is preferred that the respective configuration member can be arranged at and preferably attached to the respective configuration position in a non-positive and/or positive manner.

According to a preferred embodiment of the assembly according to the disclosure, it is provided that each configuration state corresponds to a different surface profile of the interface in the attachment of the assembly to the electronic module. Surface profile in this case means the part of the interface of the assembly which is seen by the electronic module when attaching the assembly to the electronic module. In particular, this pertains to a surface contour of a surface of the interface. The surface profile of the interface does not include, in particular, mechanical differences that are hidden behind other surfaces or other structures and in this sense are therefore situated within the assembly. The correspondence of the configuration states to surface profiles allows for making the mechanical possibility of attaching the assembly to the electronic module dependent upon a match of the encoding or configuration, especially if the electronic module is also encoded by the configuration of its surface profile.

A preferred embodiment of the assembly according to the disclosure is characterized in that a respective configuration member can be disposed in several different arrangement variants at at least some configuration positions, wherein each arrangement variant of the configuration member at the respective configuration position corresponds to a different configuration variant of the configuration position. In this case, the different arrangement variants in turn preferably correspond to different mechanical configurations. Preferably, these configuration members are the above configuration members. Therefore, it may also be that, in addition to the question of the presence or absence of the configuration member, they may also be arranged at the respective configuration position in different ways—in accordance with the arrangement variants—so that the variety of the configuration states is correspondingly larger.

Another preferred embodiment of the assembly according to the disclosure is characterized in that the respective configuration member can be disposed, at the respective configuration position, in a first and a second arrangement variant, wherein the respective configuration member, in the first arrangement variant, is disposed offset relative to the second arrangement variant in the direction of the electronic module. Particularly, this specification of direction of the offset is to be understood in relation to the attachment of the assembly to the electronic module, i.e. to a relative arrangement of the assembly with respect to the electronic module as it is required for causing the assembly to be attached to the electronic module. Such an offset in the direction of the electronic module—i.e. corresponding to the degree of protrusion in the direction of the electronic module—provides for a difference in the surface profile of the interface, which can permit or prevent mechanical attachability of the assembly to the interface in a simple manner, namely like a lock to a matching key. In this case, the absence of a configuration member from the configuration position is also to be understood as an arrangement variant in the present sense.

According to a preferred embodiment of the assembly according to the disclosure, it is provided that at least some of the possible configuration states correspond to a respective electrical configuration state, and that the interface has a query contact for querying the electrical configuration state of the interface. Alternatively or additionally to the mechanical configuration described above, several configuration states may therefore also be provided which differ also or only electrically. On the one hand, such an electrical configuration state may be provided by a quantity that can be measured directly on one or several contacts, such as a voltage or impedance. However, the electrical configuration state may also be provided by a data set that can be read out digitally and is received, if necessary, only after a handshake or the like has been carried out in accordance with a communication protocol. In this case, the above query contact generally constitutes a possibility for querying this electrical configuration state by means of an electrical contact connection and, if necessary, measurement. It is also possible that all possible configuration states correspond to a respective electrical configuration state.

A preferred embodiment of the assembly according to the disclosure is characterized in that the interface has a plurality of contact positions for arranging electrical contact members, and that different arrangements of the electrical contact members on the contact positions correspond to different configuration states. Further, it is preferred that the query contact is configured for electric connection with the contact members. In particular, it may be provided that the electrical contact members form the query contact.

Another preferred embodiment of the assembly according to the disclosure is characterized in that the contact members are electrically conductive pins, that the contact positions have openings for optionally receiving the pins, and that the assembly has one pole for each contact position, which pole is disposed such that, when a pin is received by an opening of a contact position, the received pin is electrically connected to the pole of the contact position. The pins may also be contact springs.

According to a preferred embodiment of the assembly according to the disclosure, it is provided that the contact assembly has two pole contacts for supplying the outlet valve with electricity, that the outlet valve is configured for operation by an extra-low voltage and the pole contacts are configured for being connected to the extra-low voltage. Such an extra-low voltage is a voltage which remains within the threshold values for the voltage range I according to IEC 60449, and thus a partial range of low voltage. Preferably, the extra-low voltage is 120 V at most, particularly in the case where the extra-low voltage is a direct voltage. It may also be that the extra-low voltage is 50 V at most, which applies particularly in the case where the extra-low voltage is an alternating voltage. By transmitting only an extra-low voltage via the interface for operating the outlet valve—instead of the generally higher external supply voltage of the electronic module—handling the interface, especially when attaching the assembly to the electronic module or when detaching the assembly from the electronic module, is electrically non-hazardous and can therefore also be carried out by a person not specially trained for handling higher voltages.

A preferred embodiment of the assembly according to the disclosure is characterized in that the assembly has an, in particular capacitive, sensor for detecting a filling level of the collecting chamber, and that the contact assembly has an electric sensor contact for operating the sensor. Further, it is preferred in this case that the sensor is configured for operation with a ground potential and the sensor contact is configured for being connected to the ground potential.

Another preferred embodiment of the assembly according to the disclosure is characterized in that the assembly has a seal assembly for sealing the interface when the assembly is attached to the electronic module.

According to a preferred embodiment of the assembly according to the disclosure, it is provided that the interface has a receiving portion for an attachment means, so that a non-positive connection, preferably a non-positive and positive connection, for attaching the assembly to the electronic module can be established by means of the attachment means, and that the receiving portion can be brought into one of several possible mechanical configuration states. Preferably, the receiving portion can be brought into one of several possible mechanical configuration states by means of an arrangement of a configuration member. In particular, the attachment means may be a screw, with the receiving portion preferably having a female thread for the screw. Thus, the receiving portion provided for attaching the assembly has a dual function in this variant.

A condensate draining device according to the disclosure serves for draining off a compressed-gas condensate, and has an electronic module, which electronic module has a supply assembly for generating a supply voltage, a module interface for attaching an assembly to the electronic module and for providing the supply voltage at the assembly, and a supply terminal for connecting the supply assembly to an external voltage source. Consequently, the module interface is configured so that, by means of it, the assembly is attached to the electronic module and that the supply voltage is provided at the assembly.

The condensate draining device according to the disclosure is characterized in that the condensate draining device has an assembly according to the disclosure for attachment to the electronic module. It may also be that this assembly according to the disclosure is attached to the electronic module.

A preferred embodiment of the condensate draining device according to the disclosure is characterized in that the module interface can be brought into one of several possible mechanical configurations, and that an attachment of the assembly to the electronic module is mechanically blocked in at least some mechanical configurations of the module interface and some of the possible configuration states of the interface. These some of these possible configuration states of the interface may be, in particular, some arrangement variants of the configuration members. These arrangement variants of the configuration members were already described above.

According to a preferred embodiment of the condensate draining device according to the disclosure, it is provided that the electronic module has a plurality of spaced-apart counter-configuration positions, each of which correspond to a configuration position of the assembly, that a respective counter-configuration member is optionally disposed at the counter-configuration positions, preferably, that the counter-configuration members correspond to the configuration members, and that, in case of a counter-configuration member being arranged in a counter-configuration position and a configuration member being arranged in the configuration position that corresponds to the counter-configuration position, an attachment of the assembly to the electronic module is mechanically blocked.

Preferably, the counter-configuration positions are receiving portions for arranging a respective counter-configuration member. In particular, the respective counter-configuration member is disposed and preferably attached to the respective counter-configuration position by means of a non-positive and/or positive connection. Here, it is further preferred that the counter-configuration positions are disposed on the module interface such that when the assembly is attached to the electronic module, the counter-configuration positions are adjacent to the respectively corresponding configuration positions.

Particularly in the case where the above configuration positions of the assembly are receiving portions for arranging the respective configuration member and the counter-configuration positions are receiving portions for arranging the respective counter-configuration member, it may be that when a configuration member is arranged in a configuration position and the assembly is attached to the electronic module, this configuration member protrudes into the counter-configuration position that corresponds to the configuration position and is preferably adjacent to it. Alternatively or additionally, it may be that when a counter-configuration member is arranged in a counter-configuration position and the assembly is attached to the electronic module, this counter-configuration member protrudes into the configuration position to which this counter-configuration position corresponds. In this way, the above-mentioned mechanical blocking action can be realized in a simple manner.

Another preferred embodiment of the condensate draining device according to the disclosure is characterized in that the electronic module has a logic device for detecting and checking a configuration state of the interface, which logic device can be brought into one of several possible electrical configurations, and that the logic device, in the event of a lack of conformity between the configuration state of the interface and the electrical configuration of the logic device, carries out an error routine for shutting down the assembly. According to a first preferred variant, such an error routine may comprise outputting an—in particular visual and/or acoustic—warning signal for indicating a faulty configuration of the assembly in relation to the electronic module. According to a second preferred variant, the error routine may include shutting down the assembly by the supply assembly. Thus, by the supply assembly not providing a supply voltage, the assembly does not start its function in the first place. It is further preferred that the logic device has a non-volatile memory for storing the electrical configuration. However, it is also possible that the logic device is brought into the configuration of the several possible electrical configurations by arranging switching members in accordance with different possible switching arrangements.

Other preferred features, details and developments of the condensate draining device according to the disclosure are apparent from the corresponding features, details and developments of the assembly according to the disclosure.

### BRIEF DESCRIPTION OF THE DRAWINGS

In the drawings:

FIG. 1 shows an exploded view of an inventive condensate draining device according to a first exemplary embodiment,

FIG. 2 shows a first sectional view of the condensate draining device according to the disclosure of FIG. 1,

FIG. 3 shows a second sectional view of the condensate draining device according to the disclosure of FIG. 1, and

FIG. 4 shows an exploded view of an inventive condensate draining device according to a second exemplary embodiment.

### DETAILED DESCRIPTION OF THE DRAWINGS

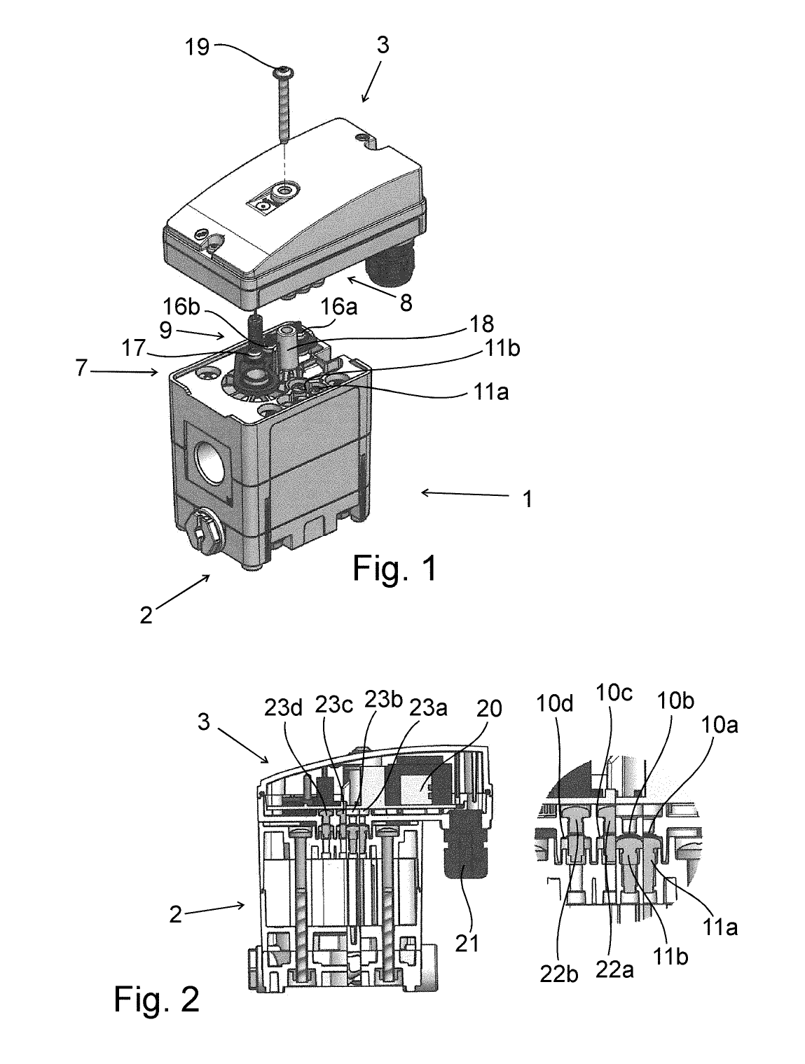

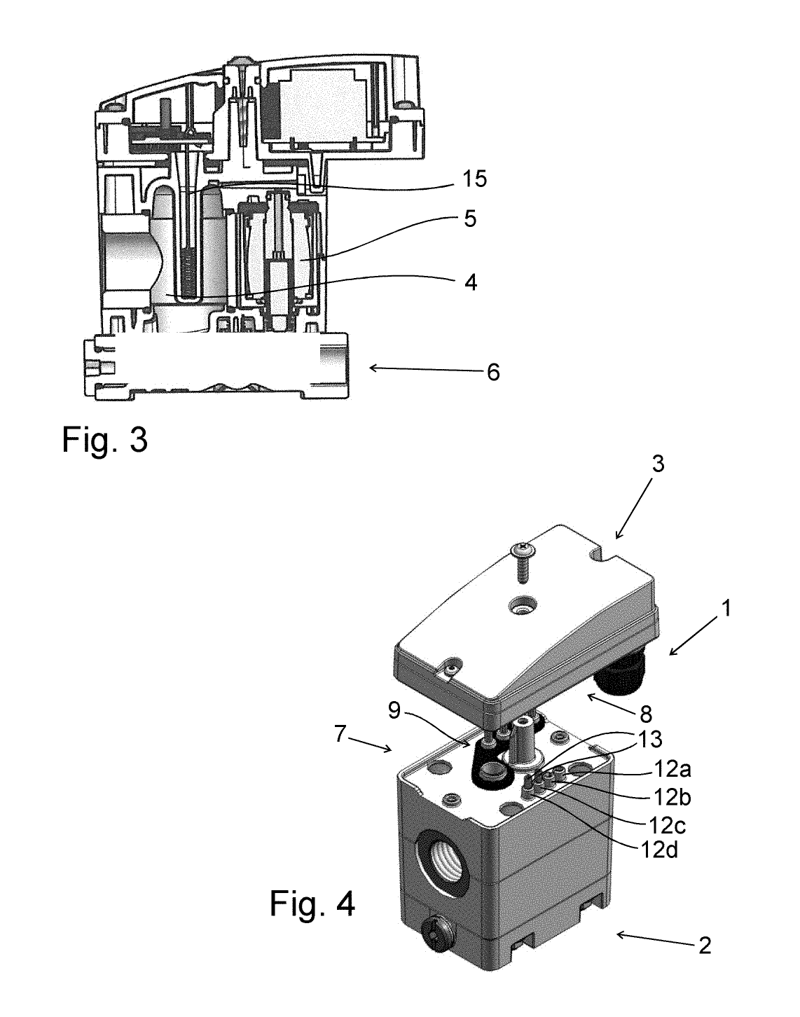

The condensate draining device 1 shown in FIG. 1, which corresponds to a first exemplary embodiment of the condensate draining device 1 according to the disclosure, has an assembly 2 and an electronic module 3 as essential components. Accordingly, this assembly 2 constitutes a first exemplary embodiment of the assembly 2 according to the disclosure. The assembly 2 may also be referred to as a maintenance assembly. The condensate draining device 1 serves for use in a compressed-gas system not shown herein, and there particularly for draining off the compressed-gas condensate. In FIG. 1, the assembly 2 and the electronic module 3 are shown separate from each other. FIGS. 2 and 3 show the condensate draining device 1 of FIG. 1, with the assembly 2 being attached to the electronic module 3, in a respective sectional view. Generally, the condensate draining device 1 as a whole is mechanically attached to the electronic module 3 with the rest of the compressed-gas system.

The assembly 2 has a collecting chamber 4 for receiving the compressed-gas condensate formed in the compressed-gas system and an electrically operated outlet valve 5—which is a solenoid valve—for discharging the compressed-gas condensate. The discharged compressed-gas condensate can escape through the outlet opening 6 of the assembly 2. The details relating to the mode of operation of the outlet valve 5, the collecting chamber 4 and the outlet opening 6—which are not relevant in the present case and are known as such from the prior art—are omitted from the illustration of FIG. 3.

The assembly 2 is attached to the electronic module 3, and especially to its module interface 8, by means of the interface 7. In the present case, the module interface 8 is simply formed by the counterpart to the module interface 7 on the electronic module 3. The interface 7 has a contact assembly 9 through which electricity can be received from the electronic module 3 for electrically supplying the outlet valve 5.

The interface 7 can be brought into different mechanical configuration states. For this purpose, it has several, and especially four, configuration positions 10a-d, which are in this particular case formed by four openings arranged side-by-side. One screw may now be optionally disposed in each of these openings. Thus, according to the illustrations of FIGS. 1 and 2, such screws are disposed in the openings of the two configuration positions 10a, b. In particular, the screws are arranged at and fastened to the configuration positions 10a, b by means of a screw connection, i.e. by means of a non-positive and positive connection. These screws form configuration members 11a, b, whose different options of being arranged or placed in the configuration positions 10a-d—i.e. the case of a screw present at the respective configuration position 10a-d versus the case of a screw absent from the respective configuration position 10a-d—make it possible to realize a total of sixteen different configuration variants and thus mechanical configuration states of the assembly 2. Each of the configuration states then recognizably yields a surface profile of the interface 7 that is different in each case.

It would also be conceivable that configuration members 11a, b, and in this case especially the screws, can be disposed in the respective configuration positions 10a-d in more than one way—e.g. protruding to different extents. In such a case, the number of the different configuration states with a different surface profile in each case would be further increased.

FIG. 4 shows a second exemplary embodiment of a condensate draining device 1 according to the disclosure, which condensate draining device 1 in turn has a second exemplary embodiment of an assembly 2 according to the disclosure.

In contrast to the first exemplary embodiment of FIGS. 1 to 3, the configuration states of the interface 7 of the assembly 2 of the second exemplary embodiment of FIG. 3 also have electrical difference in addition to the mechanical differences. In particular, the interface 7 of the assembly 2 of the second exemplary embodiment has four contact positions 12a-d, which comprises openings which may accommodate electrical contact members 13—in this case, in particular, electrically conductive pins. A pole of the assembly, which is not shown here, is in each case disposed underneath the contact position 12a-d, so that a pin is electrically connected at a contact position 12a-d to the pole underneath it.

In this manner, the contact members 13 as a whole, which are in the present case disposed at the contact positions 12c, d, form a query contact 14 of the interface 7 themselves, via which the configuration state of the interface 7 can be determined electrically. Alternatively, the contact members 13 could also have been disposed in the contact positions 12a, c or the contact positions 12 a, b, for example. A total of four contact members 13 could also have been disposed in the contact positions 12a-d. The contact members 13, or the electrical connections established by them, can be detected by corresponding contacts of the module interface 8, which are not shown here, and the respective configuration state can thus be determined. With regard to its other properties and features, the second exemplary embodiment of FIG. 4 corresponds to the first exemplary embodiment of FIGS. 1 to 3.

In both exemplary embodiments shown, the contact assembly 9 of the interface 7 has pole contacts 16a, b for supplying the outlet valve 5 with electricity. These pole contacts 16a, b receive an extra-low voltage of 100 volts, which is provided by the electronic module 3, for the operation of the outlet valve 5.

In addition, the contact assembly 9 of the interface 7 has a sensor contact 17 which is electrically connected to a ground potential by means of the electronic module 3 and which serves for operating a capacitive sensor 15 of the assembly for detecting a filling level of the collecting chamber 4. In this case, further, and in particular electronic, components for the function of the sensor 15 may be disposed in the electronic module 3.

The interface 7 has a receiving portion 18 with a female thread for an attachment means 19, which is a screw. According to a variant not shown here in much detail, fitting configuration members could also be disposed in different orientations on the receiving portion 18 with a corresponding link mechanism, so that, again, different mechanical configuration states could be provided on a structure which are required anyway for attaching the assembly 2 to the electronic module 3.

In addition to the module interface 8 already mentioned, the electronic module 3 of the condensate draining device 1 has a supply assembly 20 for generating a supply voltage. In the present case, this supply assembly 20 is a converter. Here, this supply voltage is applied to the pole contacts 16 a, b via the module interface 8 in order to supply the outlet valve 5 with electricity. The supply assembly 20 itself is in turn connected to an external voltage source—which is not shown here—via a supply terminal 21. This external voltage source preferably provides a customary alternating voltage of 230 V. An external ground contact for the sensor contact 17 may also be provided through the supply terminal.

As can be seen in FIG. 2, the module interface 8 may also be mechanically configured in different ways. In particular, the module interface 8 has four receiving portions, which form counter-configuration positions 23a-d to the configuration positions 10a-d and in which respective counter-configuration members 22a, b may be received, which in this case are also screws. As can be seen in FIG. 2, the counter-configuration positions 23a-d are immediately adjacent to the configuration positions 10a-d if the assembly 2 is attached to the electronic module 3. In the exemplary embodiment of FIG. 2, the counter-configuration members 22a, b are disposed in the configuration positions 23c, d. The corresponding screws, which are also disposed in the counter-configuration positions 23c, d by a non-positive and positive screw connection, also protrude into the adjacent configuration positions 10c, d. Conversely, the screws disposed in the configuration positions 10a, b also protrude into the counter-configuration positions 23a, b.

Thus, it is apparent that no two screws can be disposed both in one of the configuration positions 10a-d and in the respectively adjacent counter-configuration position 23a-d without mechanically blocking an attachment of the assembly 2 to the electronic module 3. A suitably complementary arrangement of the screws is thus a precondition for this attachment, so that an encoding by the placement of the screws can be mechanically checked in this manner. In this case, it is conceivable that the screws also provide an electrical connection, as described for the contact members 13, in addition to these mechanical properties.

1. An assembly for a condensate draining device for draining off a compressed-gas condensate, the assembly comprising a collecting chamber for receiving the compressed-gas condensate formed in a compressed-gas system, an electrically operated outlet valve for discharging the compressed-gas condensate from the collecting chamber, and an interface for attaching the assembly to an electronic module, wherein the interface has a contact assembly for supplying the outlet valve with electricity from the electronic module, wherein the interface is brought into one of several possible and different configuration states.

2. The assembly according to claim 1, wherein at least some of the possible configuration states correspond to a respective mechanical configuration state, and the interface has a plurality of spaced-apart configuration positions, each of which is shaped into one of several mechanical configuration variants, and that each different configuration variant of a configuration position corresponds to a different configuration state.

3. The assembly according to claim 2, wherein a respective configuration member is optionally disposed, attached in a non-positive or a positive manner, at least some configuration positions, wherein the presence of a configuration member at the respective configuration position corresponds to a first configuration variant of the configuration position, and the absence of a configuration member from the respective configuration position corresponds to a second configuration variant of the configuration position.

4. The assembly according to claim 2, wherein each configuration state corresponds to a different surface profile of the interface in the attachment of the assembly to the electronic module.

5. The assembly according to claim 2, wherein a respective configuration member is disposed in several different arrangement variants at least some configuration positions, wherein each arrangement variant of the configuration member at the respective configuration position corresponds to a different configuration variant of the configuration position.

6. The assembly according to claim 5, wherein the respective configuration member is disposed, at the respective configuration position, in a first arrangement variant and a second arrangement variant, wherein the respective configuration member, in the first arrangement variant, is disposed offset relative to the second arrangement variant in the direction of the electronic module, in relation to the attachment of the assembly to the electronic module.

7. The assembly according to claim 1, wherein at least some of the possible configuration states correspond to a respective electrical configuration state, and that the interface has a query contact for querying the electrical configuration state of the interface.

8. The assembly according to claim 7, wherein the interface has a plurality of contact positions for arranging electrical contact members, and that different arrangements of the electrical contact members on the contact positions correspond to different configuration states, that the query contact is configured for electric connection with the contact members, that the electrical contact members form the query contact.

9. The assembly according to claim 8, wherein the contact members are electrically conductive pins, that the contact positions have openings for optionally receiving the pins, and that the assembly has one pole for each contact position, which pole is disposed such that, when a pin is received by an opening of a contact position, the received pin is electrically connected to the pole of the contact position.

10. The assembly according to claim 1, wherein the contact assembly has two pole contacts for supplying the outlet valve with electricity, that the outlet valve is configured for operation by an extra-low voltage and the pole contacts are configured for being connected to the extra-low voltage, wherein the extra-low voltage is at most 120 V.

11. The assembly according to claim 1, wherein the assembly has a capacitive, sensor for detecting a filling level of the collecting chamber, and that the contact assembly has an electric sensor contact for operating the sensor, wherein the sensor is configured for operation with a ground potential and the sensor contact is configured for being connected to a ground potential.

12. The assembly according to claim 1, wherein the interface has a receiving portion for an attachment means, so that at least a non-positive connection for attaching the assembly to the electronic module is established by means of the attachment means, and that the receiving portion, by means of an arrangement of a configuration member, is brought into one of several possible mechanical configuration states.

13. A condensate draining device for draining off a compressed-gas condensate, with an electronic module, which electronic module has a supply assembly for generating a supply voltage, a module interface for attaching an assembly to the electronic module and for providing the supply voltage at the assembly, and a supply terminal for connecting the supply assembly to an external voltage source, characterized in that the condensate draining device has an assembly according to claim 1 for attachment to the electronic module.

14. The condensate draining device according to claim 13, wherein the module interface is brought into one of several possible mechanical configurations, and that an attachment of the assembly to the electronic module is mechanically blocked in at least some mechanical configurations of the module interface and some of the possible configuration states of the interface, in some arrangement variants of the configuration members.

15. The condensate draining device according to claim 13, wherein the electronic module has a logic device for detecting and checking a configuration state of the interface, which logic device is brought into one of several possible electrical configurations, and that the logic device, in the event of a lack of conformity between the configuration state of the interface and the electrical configuration of the logic device, carries out an error routine for shutting down the assembly, that the logic device has a non-volatile memory for storing the electrical configuration.
